(19) United States
(12) Patent Application Publication
(10) Pub. No.: US 2025/0181257 A1
(43) Pub. Date: Jun. 5, 2025

(54) READ STATUS COMMAND TO OBTAIN CHANNEL STATE

(71) Applicant: Micron Technology, Inc., Boise, ID (US)

(72) Inventor: David Aaron Palmer, Boise, ID (US)

(21) Appl. No.: 18/957,319

(22) Filed: Nov. 22, 2024

Related U.S. Application Data
(60) Provisional application No. 63/604,767, filed on Nov. 30, 2023.

(51) Int. Cl. G06F 3/06

(52) U.S. Cl. CPC G06F 3/0632; G06F 3/0619; G06F 3/0679

(57) ABSTRACT

Methods, systems, and devices for a read status command to obtain channel state are described. In some examples, a boot sequence may be initiated at a controller of a memory system based on receiving a power signal, and a first request for status information may be transmitted from the controller to a memory device of the memory system. The controller may receive an indication of an initialization status from the memory device, and configure a channel interface for communicating with the memory device based on the indication of the initialization status. Data may subsequently be communicated between the controller and the memory device using the channel interface.

### CROSS REFERENCE

The present Application for Patent claims priority to U.S. Patent Application No. 63/604,767 by Palmer, entitled “READ STATUS COMMAND TO OBTAIN CHANNEL STATE,” filed Nov. 30, 2023, which is assigned to the assignee hereof, and which is expressly incorporated by reference herein.

### TECHNICAL FIELD

The following relates to one or more systems for memory, including a read status command to obtain channel state.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports a read status command to obtain channel state in accordance with examples as disclosed herein.

FIG. 2 illustrates an example of a system that supports a read status command to obtain channel state in accordance with examples as disclosed herein.

FIG. 3 illustrates an example of a flow diagram for a process that supports a read status command to obtain channel state in accordance with examples as disclosed herein.

FIG. 4 illustrates a block diagram of a memory system that supports a read status command to obtain channel state in accordance with examples as disclosed herein.

FIG. 5 illustrates a flowchart showing a method or methods that support a read status command to obtain channel state in accordance with examples as disclosed herein.

### DETAILED DESCRIPTION

Memory systems often utilize multiple power supplies to operate different components. For example, a controller within the memory system (e.g., memory system controller) may be powered by a first power supply, and the memory device (or devices) may be powered by a different power supply. For various reasons, the power supplies may not all experience the same power conditions. For example, a host system associated with the memory system may implement different power supply or control circuits that involve some power supplies experiencing brown-out conditions while other power supplies remain stable. In some cases, the brownout conditions may affect the memory system controller and not the memory device. Consequently, power to the memory system controller may be interrupted and configuration and/or communication settings may be lost. The memory device, however, may not have been power cycled and retained configurations for communicating via the channel interface.

When power is returned to the memory system controller, the status of the channel interface for communicating with the memory device as well as the status of the memory device may be unknown. This can lead to delays due to lack of a shared state between the memory system controller and the memory device for communicating over the channel interface. The memory system controller may undergo a process for resetting and reinitializing its connection to the channel interface, which may result in delays. The memory system controller may also reset the memory device, which may cause additional training and configuration before communication can resume, which may result in further delays. If the memory device was not power cycled, however, configuration parameters for the channel interface are maintained by the memory device. Thus, the additional training and configuration of the memory device may be unnecessary.

According to various aspects of the present disclosure, the memory system controller may, after a reset condition, communicate a status command to obtain information regarding the status of the memory device and the channel interface. In some examples, the status command may be used to determine if the memory device was powered down or remained active. If the memory device was previously configured (e.g., remained active), the status command may cause the return of information such as the currently configured data rate, timing mode, and/or protocol (e.g., serial command and address or legacy) for the channel interface. The memory system controller may utilize the received information to configure its connection to the channel interface. The status command may further be used to obtain some or all available state parameters associated with the channel interface. In some examples, the status command may be valid in all timing modes or configurations for the channel interface. The memory system controller may therefore successfully communicate the status command regardless of the channel configuration of the memory device. In other examples, the status command may be valid regardless of whether the memory device is available or busy.

According to the disclosed examples, a faster and more robust reset recovery flow may be achieved for the memory system controller using the status command. In some examples, a memory system controller which has been reset or powered on may communicate the status command to determine whether the memory device has remained powered on, thereby avoiding the need to blindly reset the memory device. The memory system controller may also avoid resetting an already configured and initialized memory device. In some examples, the status command may cause the memory system to achieve improved (e.g., faster) synchronization between memory device and memory system controller, while reducing the possibility of failures. Furthermore, the memory system controller may potentially skip unneeded training and calibration steps which can cause operational delays.

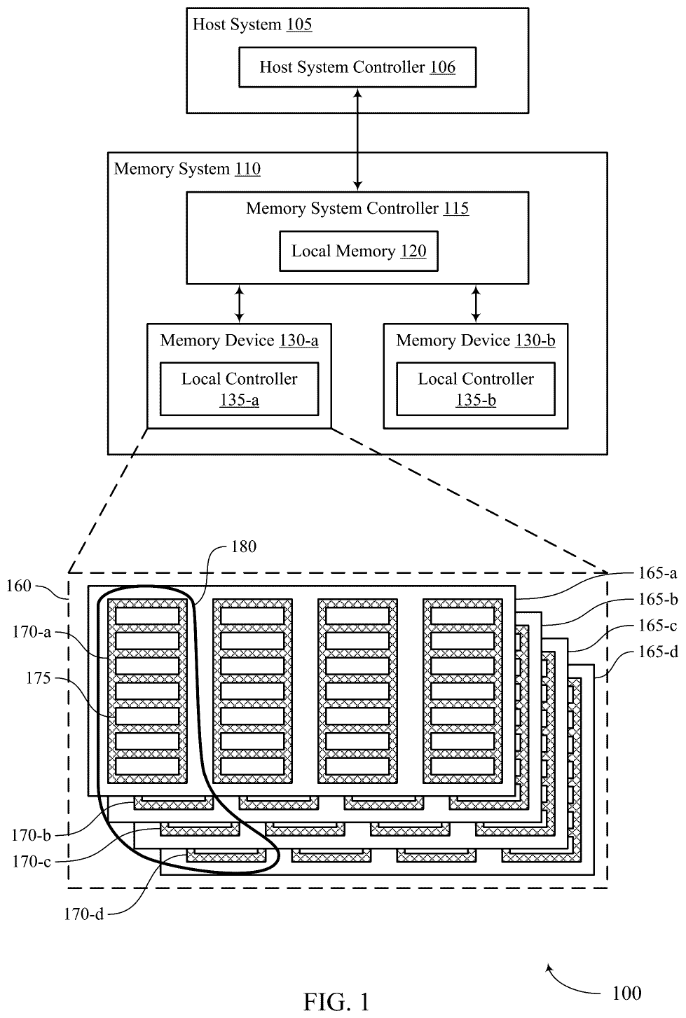

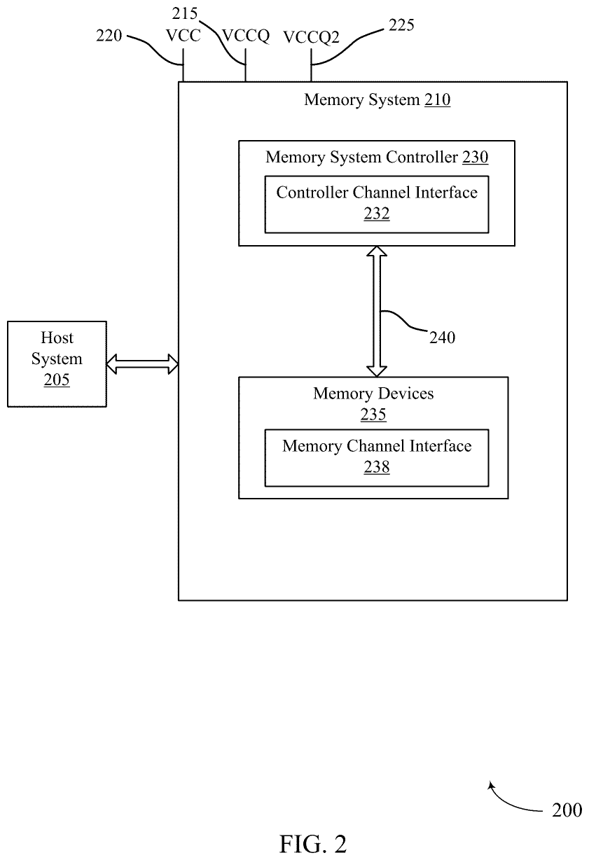

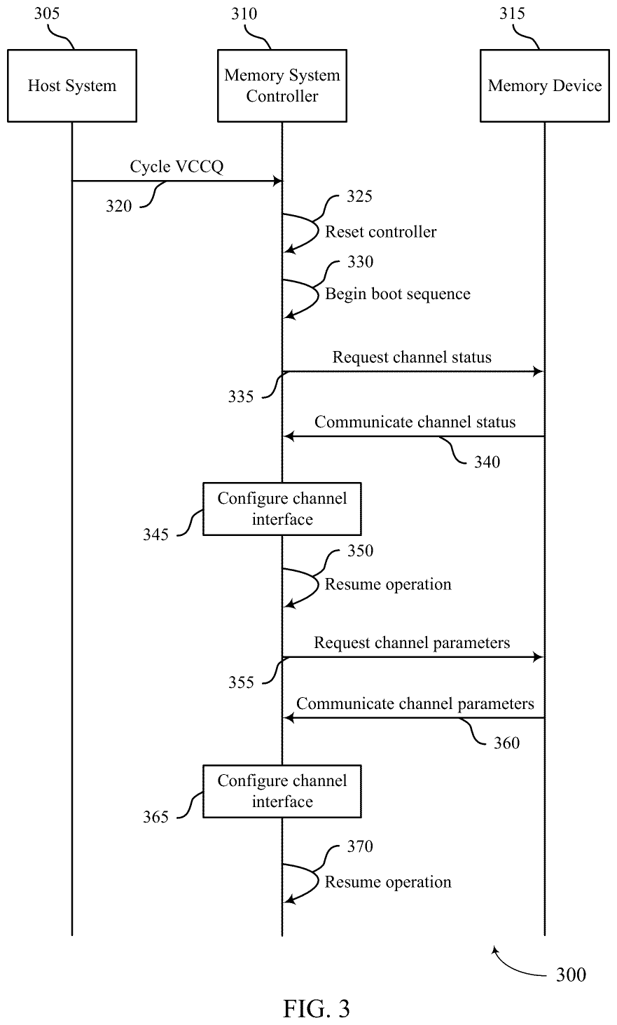

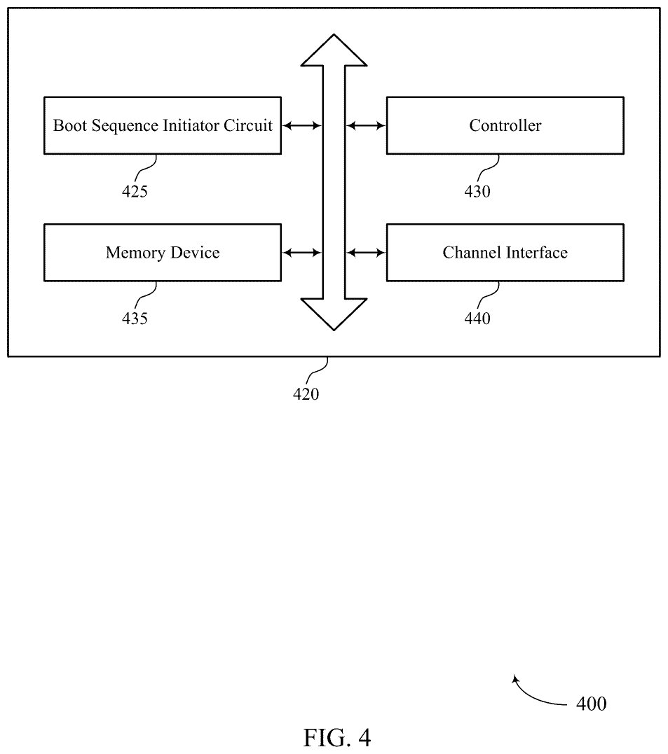

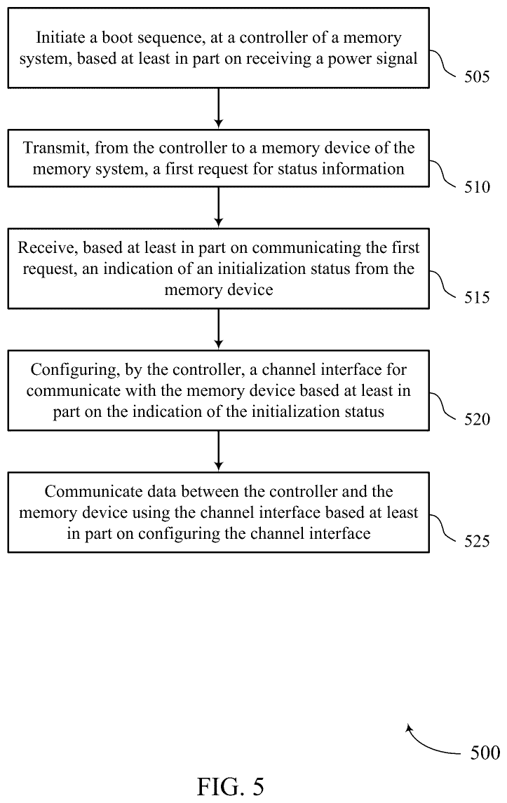

Features of the disclosure are initially described in the context of systems, devices, and circuits with reference to FIG. 1. Features of the disclosure are described in the context of a system that supports a read status command to obtain channel state and a flow diagram for a process that supports a read status command to obtain channel state with reference to FIGS. 2 through 3. These and other features of the disclosure are further illustrated by and described in the context of an apparatus diagram and flowchart that relate to a read status command to obtain channel state with reference to FIGS. 4 through 5.

FIG. 1 illustrates an example of a system 100 that supports a read status command to obtain channel state in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support a read status command to obtain channel state. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, the memory system controller, such as memory system controller 115, may initiate a boot sequence based at least in part on receiving a power signal. The power signal may be interrupted as part of various operations or conditions experienced by a host system, such as the host system 105. The memory system controller 115 may transmit a first request for status information to a memory device, such as memory device 130. In response, the memory system controller 115 may receive an initialization status from the memory device 130. The memory system controller 115 may subsequently configure a channel interface for communicating with the memory device 130 based at least in part on the received initialization status. The memory system controller 115 may then communicate data with the memory device 130 using the channel interface.

FIG. 2 illustrates an example of a system 200 that supports a read status command to obtain channel state in accordance with examples as disclosed herein. According to the examples disclosed herein, the system 200 may include a memory system 210 configured to operate using two or more power rails. Each power rail may be configured to supply voltage to the memory system 210 from a source such as a host system 205 or a chassis that supplies power to both the host system 205 and the memory system 210. The first power rail 215 (e.g., VccQ signal) may be used to power the memory system controller 230 as well as I/O operations for the memory device 235. The second power rail 220 (e.g., Vcc signal) may be used to power the memory device 235 (e.g., power the internal functions of the memory device 235 such as a controller, data latches, or one or more NAND arrays). In some examples, the host system 205 or chassis may supply a third power rail 225 (e.g., VccQ2 signal) which may be used to power a memory system controller of legacy UFS devices (e.g., pre-UFS v3.0).

For example, memory systems implementing UFS protocols such as UFS v3.0 or greater may utilize the first power rail 215 to supply the VccQ signal to the memory system controller 230 and the I/O circuitry of the memory device 235 and second power rail 220 to supply the Vcc signal to the memory device 235. Memory systems implementing legacy UFS protocols (pre-UFS v3.0) may utilize the second power rail 220 to supply the Vcc signal to the memory device and the third power rail 225 to supply the VccQ2 signal to the memory system controller 230. The voltage supplied to the first power rail 215, second power rail 220, and third power rail 225 may be different in order to accommodate the specific circuits and protocols being implemented. For example, the VccQ signal supplied via the first power rail 215 may be nominally 1.2V, and the Vcc signal supplied via the second power rail 220 may be nominally 3.3V. Additionally, the VccQ2 signal supplied via the third power rail 225 may be nominally 1.85V. According to the illustrated example, the memory system 210 may include a channel interface 240 to facilitate communication between the memory system controller 230 and the memory device 235. In some examples, the channel interface 240 may implement the Open NAND Flash Interface (ONFI) protocols. The memory system controller 230 may include a controller channel interface 232 and the memory devices 235 may include a memory channel interface 238. The controller channel interface 232 and the memory channel interface 238 may be configured for communication according to the channel interface 240 (e.g., may be configured according to parameters for communication such as data interface type, differential signaling, interface mode, or data rate). In some of the data interface types or interface modes, training may be employed to optimize timing margins (e.g., strobe placement). When the memory system controller 230 and memory device 235 are powered up, they may go through a configuration (and training, if applicable) process for the controller channel interface 232 and the memory channel interface 238 for communication over the channel interface 240. Once the configuration and training is complete, the memory device 235 may apply configuration parameters which enable communication using the channel interface 240.

In accordance with one or more examples described herein, the host system 205 may intentionally or unintentionally brownout (e.g., power down or allow to dip below a normal range) the first power rail 215 (or VccQ rail) while the second power rail 220 (or Vcc rail) remains stable. This operation causes the memory system controller 230 to be reset (e.g., power cycled). When the memory system controller 230 reboots from the reset condition, it is not aware of the current state of the memory channel interface 238. For example, the memory system controller 230 may not be aware of whether or not the memory device 235 was reset or remained operational. According to an example, the channel interface 240 between the memory device 235 and the memory system controller 230 may be an on-demand interface. Therefore, an idle period may result during the time in which the memory system controller 230 is reset (or powered down), where no communication takes place. In such cases, the memory device 235 may be unaware that the memory system controller 230 was powered down. In some examples, the memory device 235 may be powered down simultaneously or separately from the memory system controller 230.

According to the disclosed examples, the memory system controller 230 may query the memory device 235, by communicating a channel status request, in order to determine whether or not the memory device 235 has been powered on through a power cycle event of the memory system controller 230. In such cases, the memory device 235 may have previously configured parameters to be used for communicating using the channel interface 240. According to the examples disclosed herein, the status request from the memory system controller 230 would result in communication of the state parameters currently being used by the memory channel interface 238 of the memory device 235 to communicate via the channel interface 240. The memory system controller 230 may use this information to configure the controller channel interface 232, thereby omitting configuration (and training, if applicable) and other operations to reestablish configuration of the memory channel interface 238 of the memory device 235 after a power reset.

According to one example, the memory system controller 230 may communicate a request for channel status to the memory device 235. The request for channel status may be communicated as a modification of a read status command defined for ONFI. However, the modified command may have additional properties which allow certain interface parameters to be communicated from the memory device 235 in response to the command being received. In some examples, the request for channel status (or modified read status command) communicated from the memory system controller 230 may be a request to determine whether or not the memory device 235 is already configured. In other words, the modified command may determine if the memory device 235 was not powered down, and therefore is ready to receive commands and data. In one or more examples, the memory system controller 230 may communicate a reset command to the memory device 235 if it determines the memory device 235 was subject to a power loss.

The request for channel status may also result in communication of an indication of the speed mode at which the memory device 235 has been operating, if it was already configured. For example, the memory channel interface 238 of the memory device 235 may be operating in a high-speed mode or a low-speed mode. In one example, the memory device 235 may communicate an indication to the memory system controller 230 that the memory channel interface 238 is configured for operation in a given mode such as the high-speed mode. According to the disclosed examples, the memory system controller 230 may communicate a second request to obtain additional configuration parameters (e.g., channel parameters) to improve and/or optimize communication with the memory device 235 via the channel interface 240. The memory system controller 230 may configure the controller channel interface 232 for operation in the mode indicated by the memory device 235 such that communication of data may continue using the indicated mode without reconfiguring the memory channel interface 238.

FIG. 3 illustrates an example of a flow diagram for a process 300 that supports a read status command to obtain channel state in accordance with examples as disclosed herein. At 320, the host system 305 may cycle the supply voltage being provided to the first power rail (e.g., intentionally or unintentionally). This may correspond, for example, to a brownout condition where the supply of power for the first power rail is interrupted for an amount of time. In some examples, the first power rail may correspond to a distribution node for a VccQ signal which supplies voltage to the PHY interface of the memory device 315, memory system controller 310, etc. If the host system 305 (or chassis) cycles the power to the first power rail (e.g., first power supply), the memory system controller 310 may lose power and be deactivated. In some examples, the host system 305 may include a power manager that may cause a power cycle (e.g., brownout) of the first power rail 215 due to power conditions of the host system 305. In other examples, the host system 305 or a chassis may include circuitry, code, and/or components for controlling and managing power to the first power rail.

At 325, the memory system controller 310 is reset. This may correspond to a power up sequence for the memory system controller 310. At 330, the memory system controller may begin its boot sequence operation. In some examples, the boot sequence may include initializing various components so that the memory system controller 310 may begin performing access operations (e.g., read, write, erase, etc.) with the memory device 315. At 335, the memory system controller 310 communicates a request for channel status to the memory device 315. In some examples, the request for channel status may be in the form of a NAND status command, such as a read status command or modified read status command, to determine an initialization state for the memory device 315. In other examples, the request for channel status may correspond to a first request for status information communicated by the memory system controller 310. In other examples, the memory device 315 may include multiple memory die, and the memory system controller 310 may poll the memory die sequentially or in parallel. When the memory system controller 310 polls multiple memory die sequentially, the CE pin on the memory device 315 may be used to select the memory die for the command. When the memory system controller 310 polls multiple memory die in parallel, different die may be assigned to different portions of the data bus of the channel interface such that initialization state information for the multiple memory die may be received using a single request for channel status.

According to at least one example, the request for channel status may be communicated by the memory system controller 310 using parameters that may be recognized by, or valid to, the memory device 315 under any operating conditions. In some examples, such parameters may be in the form of default parameters (e.g., slowest speed for the channel interface, channel settings applicable to all operating modes) available to the memory device 315. Thus, regardless of the current operating mode of the memory device 315 the request for channel status may be received from the memory system controller 310. More particularly, the request for channel status may be communicated such that it is valid in all timing modes, all configurations of the channel interface parameters, both legacy and serial command and address (SCA) protocols. In some examples, the request for channel status may be issued even when the memory device 315 is determined to be busy based on status bits used to represent command array operations in ONFI. For example, bits 5 and 6 of a status register may be used to determine whether the memory device 315 is busy or available. In some examples, bit 5 (ARDY) may be set to one (ARDY=1) to indicate no array operation in progress. ARDY may be cleared (or set) to zero (ARDY=0) to indicate a command being processed or an array operation in progress. Bit 6 (RDY) may be set to one (RDY=1) to indicate the LUN or plane address is ready for another command and all other bits in the status value are valid. RDY may be cleared to zero (RDY=0) to indicate the last command issued is not yet complete. Thus, the request for channel status may be issued regardless of the status values for RDY and ARDY.

At 340, the memory device may communicate a channel status to the memory system controller 310. Since the memory system controller 310 has recently been reset, it may not be aware of the operational state of the memory device 315. For example, the memory device 315 may also have experienced a power cycle or reset operation. In such cases, the channel status communicated by the memory device 315 may provide an indication that the memory device 315 has recently been reset, and the channel interface has not been configured. Alternatively, the memory device 315 may have been powered continuously while the memory system controller 310 was reset. Accordingly, the memory device 315 may have maintained its internal settings and parameters as well as configuration parameters for the channel interface. In such examples, the channel status communicated at 340 may include an indication of the initialization state for the memory device 315 in order to establish communication over the channel interface.

According to one example, the channel status communicated at 340 may include a configuration parameter associated with the channel interface. For example, the memory device 315 may drive the I/Os on the bus to values that correspond to status bits. Thus, there may be one or more bits for speed, data rate, timing mode, etc. According to other examples, the channel status may include more than one configuration parameters associated with the channel interface. For example, if the memory device 315 remained active during the reset operation of the memory system controller 310, the channel status may include configuration information such as whether the channel interface is operating using legacy or SCA protocols. The channel status may also include speed, data rate, timing mode, etc., associated with the channel interface. At 345, the memory system controller 310 may utilize the channel status information received at 340 in order to configure its connection to the channel interface, thereby enabling communicating with the memory device 315. For example, the memory system controller 310 may utilize the channel status information to establish a particular data rate or timing mode that can be used to successfully exchange or communicate information with the memory device 315 over the channel interface.

At 350, the memory system controller 310 may resume operations with the memory device 315 based on the parameters used to configure its connection to the channel interface. According to one or more examples, the memory system controller 310 may utilize other configuration parameters to improve and/or optimize communication with the memory device 315. At 355, the memory system controller 310 may communicate a request for channel parameters to the memory device 315. The channel parameters may correspond to state parameters associated with the channel interface. The request for channel parameters communicated at 355 may correspond, in some examples, to a second request that is communicated to the memory device 315. Similar to the request channel status communicated at 335, the request for channel parameters may be configured as a NAND status command such as a read status command or modified read status command.

In at least one example, the request for channel parameters may provide an indication of specific parameters being requested by the memory system controller 310. For example, the request for channel parameters may only specify communication of the interface mode parameter. In another example, the request for channel parameters may specify communication of the ZQ calibration status, warmup cycle configuration, and duty cycle correction information. In other examples, the request for channel parameters may include an indication that all available channel parameters should be communicated. Such channel parameters may include, for example, interface mode (NV-DDR3/NV-DDR4/etc.), use of differential signaling, state of VrefQ configuration, ZQ calibration status, warmup cycle configuration, duty cycle correction information, read/write training information, etc. It should be noted that the foregoing list is not intended to be exhaustive and other channel parameters may be available.

At 360, the memory device 315 communicates the channel parameters to the memory system controller 310. In one example, the memory device 315 may only communicate channel parameters that are specified in the request from the memory system controller 310. Accordingly, the memory device 315 may communicate a single parameter or multiple parameters. In other examples, the memory device 315 may communicate all available parameters to the memory system controller 310. As previously discussed, the channel parameters communicated by the memory device 315 may include, for example, interface mode (NV-DDR3/NV-DDR4/etc.), use of differential signaling, state of VrefQ configuration, ZQ calibration status, warmup cycle configuration, duty cycle correction information, read/write training information, etc. At 365, the memory system controller 310 may utilize the channel parameters received at 360 to modify or improve the configuration of its connection to the channel interface for communicating with the memory device 315. At 370, the memory system controller 310 resumes operation with the memory device 315.

FIG. 4 illustrates a block diagram 400 of a memory system 420 that supports a read status command to obtain channel state in accordance with examples as disclosed herein. The memory system 420 may be an example of aspects of a memory system as described with reference to FIGS. 1 through 3. The memory system 420, or various components thereof, may be an example of means for performing various aspects of a read status command to obtain channel state as described herein. For example, the memory system 420 may include a boot sequence initiator circuit 425, a controller 430, a memory device 435, a channel interface 440, or any combination thereof. Each of these components may communicate, directly or indirectly, with one another (e.g., via one or more buses).

The boot sequence initiator circuit 425 may be configured as or otherwise support a means for initiating a boot sequence based at least in part on receiving a power signal. The boot sequence initiator circuit 425 may be a part of the controller 430, in some examples. The controller 430 may be configured as or otherwise support a means for transmitting, to a memory device (e.g., memory device 435) of the memory system, 420 a first request for status information. The controller 430 may be configured as or otherwise support a means for receiving, based at least in part on communicating the first request, an indication of an initialization status from the memory device. The memory device 435 may, in some examples, be configured as or otherwise support a means for transmitting, based at least in part on receiving the first request for status information, an indication of an initialization status of the memory device to the controller 430. In some examples, the controller 430 may be configured as or otherwise support a means for configuring a channel interface (e.g., channel interface 440) for communicating with the memory device based at least in part on the indication of the initialization status. The channel interface 440 may be configured as or otherwise support a means for communicating data between the controller 430 and the memory device 435.

In some examples, the controller 430 may be configured as or otherwise support a means for receiving, from the memory device 435, at least one configuration parameter associated with the channel interface 440 based at least in part on the first request for status information.

In some examples, the controller 430 may be configured as or otherwise support a means for receiving, from the memory device 435, an indication of one or more of a type, a data rate, or a timing mode associated with the channel interface 440 based at least in part on the first request for status information.

In some examples, the controller 430 may be configured as or otherwise support a means for transmitting, based at least in part on receiving the indication of the initialization status, a second request for state information associated with the channel interface 440. In some examples, the controller 430 may be configured as or otherwise support a means for receiving one or more state parameters associated with the channel interface 440 based at least in part on transmitting the second request, where configuring the channel interface 440 for communicating with the memory device 435 is based at least in part on receiving the one or more state parameters.

In some examples, the one or more state parameters include one or more of a current interface mode, use of differential signaling, reference voltage (VrefQ) configuration, ZQ calibration status, warmup cycle configuration, duty cycle correction information, or read/write training information.

In some examples, the controller 430 may be configured as or otherwise support a means for transmitting a third request to the memory device 435 based at least in part on the indication of the initialization status indicating a power loss for the memory device 435, where the third request indicates for the memory device to perform a reset operation.

In some examples, the channel interface 440 supports a plurality of timing modes that each include one or more transmission parameters corresponding to different data communication rates and the first request for status information is transmitted using values of the one or more transmission parameters supported by each of the plurality of timing modes.

In some examples, the power signal received at the controller is a power supply for input/output drivers of the memory device.

FIG. 5 illustrates a flowchart showing a method 500 that supports a read status command to obtain channel state in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include initiating a boot sequence, at a controller of a memory system, based at least in part on receiving a power signal. The operations of 505 may be performed in accordance with examples as disclosed herein. In some examples, aspects of the operations of 505 may be performed by a boot sequence initiator circuit 425 as described with reference to FIG. 4.

At 510, the method may include transmitting, from the controller to a memory device of the memory system, a first request for status information. The operations of 510 may be performed in accordance with examples as disclosed herein. In some examples, aspects of the operations of 510 may be performed by a controller 430 as described with reference to FIG. 4.

At 515, the method may include receiving, based at least in part on communicating the first request, an indication of an initialization status from the memory device. The operations of 515 may be performed in accordance with examples as disclosed herein. In some examples, aspects of the operations of 515 may be performed by a controller 430 as described with reference to FIG. 4.

At 520, the method may include configuring, by the controller, a channel interface for communicating with the memory device based at least in part on the indication of the initialization status. The operations of 520 may be performed in accordance with examples as disclosed herein. In some examples, aspects of the operations of 520 may be performed by a controller 430 as described with reference to FIG. 4.

At 525, the method may include communicating data between the controller and the memory device using the channel interface based at least in part on configuring the channel interface. The operations of 525 may be performed in accordance with examples as disclosed herein. In some examples, aspects of the operations of 525 may be performed by a channel interface 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for initiating a boot sequence, at a controller of a memory system, based at least in part on receiving a power signal; transmitting, from the controller to a memory device of the memory system, a first request for status information; receiving, based at least in part on communicating the first request, an indication of an initialization status from the memory device; configuring, by the controller, a channel interface for communicating with the memory device based at least in part on the indication of the initialization status; and communicating data between the controller and the memory device using the channel interface based at least in part on configuring the channel interface.

Aspect 2: The method, apparatus, or non-transitory computer-readable medium of aspect 1, further including operations, features, circuitry, logic, means, or instructions, or any combination thereof for receiving, from the memory device, at least one configuration parameter associated with the channel interface based at least in part on the first request for status information.

Aspect 3: The method, apparatus, or non-transitory computer-readable medium of any of aspects 1 through 2, further including operations, features, circuitry, logic, means, or instructions, or any combination thereof for receiving, from the memory device, an indication of one or more of a type, a data rate, or a timing mode associated with the channel interface based at least in part on the first request for status information.

Aspect 4: The method, apparatus, or non-transitory computer-readable medium of any of aspects 1 through 3, further including operations, features, circuitry, logic, means, or instructions, or any combination thereof for transmitting, from the controller based at least in part on receiving the indication of the initialization status, a second request for state information associated with the channel interface and receiving one or more state parameters associated with the channel interface based at least in part on transmitting the second request, where configuring the channel interface for communicating with the memory device is based at least in part on receiving the one or more state parameters.

Aspect 5: The method, apparatus, or non-transitory computer-readable medium of aspect 4, where the one or more state parameters include one or more of a current interface mode, use of differential signaling, reference voltage (VrefQ) configuration, ZQ calibration status, warmup cycle configuration, duty cycle correction information, or read/write training information.

Aspect 6: The method, apparatus, or non-transitory computer-readable medium of any of aspects 1 through 5, further including operations, features, circuitry, logic, means, or instructions, or any combination thereof for transmitting a third request to the memory device based at least in part on the indication of the initialization status indicating a power loss for the memory device, where the third request indicates for the memory device to perform a reset operation.

Aspect 7: The method, apparatus, or non-transitory computer-readable medium of any of aspects 1 through 6, where the channel interface supports a plurality of timing modes that each include one or more transmission parameters corresponding to different data communication rates and the first request for status information is transmitted using values of the one or more transmission parameters supported by each of the plurality of timing modes.

Aspect 8: The method, apparatus, or non-transitory computer-readable medium of any of aspects 1 through 7, where the power signal received at the controller is a power supply for input/output drivers of the memory device.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin film. Layers or levels may include different elements, components, and/or materials. In some examples, one layer or level may be composed of two or more sublayers or sublevels.

As used herein, the term “substantially” means that the modified characteristic (e.g., a verb or adjective modified by the term substantially) need not be absolute but is close enough to achieve the advantages of the characteristic.

As used herein, the term “electrode” may refer to an electrical conductor, and in some examples, may be employed as an electrical contact to a memory cell or other component of a memory array. An electrode may include a trace, wire, conductive line, conductive layer, or the like that provides a conductive path between elements or components of a memory array.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily doped, e.g., degenerate, semiconductor region. The source and drain may be separated by a lightly doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
initiating a boot sequence, at a controller of a memory system, based at least in part on receiving a power signal;
transmitting, from the controller to a memory device of the memory system, a first request for status information;
receiving, based at least in part on communicating the first request, an indication of an initialization status from the memory device;
configuring, by the controller, a channel interface for communicating with the memory device based at least in part on the indication of the initialization status; and
communicating data between the controller and the memory device using the channel interface based at least in part on configuring the channel interface.

2. The method of claim 1, further comprising:
receiving, from the memory device, at least one configuration parameter associated with the channel interface based at least in part on the first request for status information.

3. The method of claim 1, further comprising:
receiving, from the memory device, an indication of one or more of a type, a data rate, or a timing mode associated with the channel interface based at least in part on the first request for status information.

4. The method of claim 1, further comprising:
transmitting, from the controller based at least in part on receiving the indication of the initialization status, a second request for state information associated with the channel interface; and
receiving one or more state parameters associated with the channel interface based at least in part on transmitting the second request, wherein configuring the channel interface for communicating with the memory device is based at least in part on receiving the one or more state parameters.

5. The method of claim 4, wherein the one or more state parameters include one or more of a current interface mode, use of differential signaling, reference voltage (VrefQ) configuration, ZQ calibration status, warmup cycle configuration, duty cycle correction information, or read/write training information.

6. The method of claim 1, further comprising:
transmitting a third request to the memory device based at least in part on the indication of the initialization status indicating a power loss for the memory device, wherein the third request indicates for the memory device to perform a reset operation.

7. The method of claim 1, wherein the channel interface supports a plurality of timing modes that each include one or more transmission parameters corresponding to different data communication rates and the first request for status information is transmitted using values of the one or more transmission parameters supported by each of the plurality of timing modes.

8. The method of claim 1, wherein the power signal received at the controller is a power supply for input/output drivers of the memory device.

9. An apparatus, comprising:
a controller associated with a memory device, wherein the controller is configured to cause the apparatus to:
initiate a boot sequence, at a controller of a memory system, based at least in part on receiving a power signal;
transmit, from the controller to a memory device of the memory system, a first request for status information;
receive, based at least in part on communicating the first request, an indication of an initialization status from the memory device;
configure, by the controller, a channel interface for communicate with the memory device based at least in part on the indication of the initialization status; and
communicate data between the controller and the memory device using the channel interface based at least in part on configuring the channel interface.

10. The apparatus of claim 9, wherein the controller is further configured to cause the apparatus to:
receive, from the memory device, at least one configuration parameter associated with the channel interface based at least in part on the first request for status information.

11. The apparatus of claim 9, wherein the controller is further configured to cause the apparatus to:
receive, from the memory device, an indication of one or more of a type, a data rate, or a timing mode associated with the channel interface based at least in part on the first request for status information.

12. The apparatus of claim 9, wherein the controller is further configured to cause the apparatus to:
transmit, from the controller based at least in part on receiving the indication of the initialization status, a second request for state information associated with the channel interface; and
receive one or more state parameters associated with the channel interface based at least in part on transmitting the second request, wherein configuring the channel interface for communicating with the memory device is based at least in part on receiving the one or more state parameters.

13. The apparatus of claim 12, wherein the one or more state parameters include one or more of a current interface mode, use of differential signaling, reference voltage (VrefQ) configuration, ZQ calibration status, warmup cycle configuration, duty cycle correction information, or read/write training information.

14. The apparatus of claim 9, wherein the controller is further configured to cause the apparatus to:
transmit a third request to the memory device based at least in part on the indication of the initialization status indicating a power loss for the memory device, wherein the third request indicates for the memory device to perform a reset operation.

15. The apparatus of claim 9, wherein the channel interface supports a plurality of timing modes that each include one or more transmission parameters corresponding to different data communication rates and the first request for status information is transmitted using values of the one or more transmission parameters supported by each of the plurality of timing modes.

16. The apparatus of claim 9, wherein the power signal received at the controller is a power supply for input/output drivers of the memory device.

17. An apparatus, comprising:
a processor;
memory coupled with the processor; and
instructions stored in the memory and executable by the processor to cause the apparatus to:
initiate a boot sequence, at a controller of a memory system, based at least in part on receiving a power signal;
transmit, from the controller to a memory device of the memory system, a first request for status information;
receive, based at least in part on communicating the first request, an indication of an initialization status from the memory device;
configure, by the controller, a channel interface for communicate with the memory device based at least in part on the indication of the initialization status; and
communicate data between the controller and the memory device using the channel interface based at least in part on configuring the channel interface.

18. The apparatus of claim 17, wherein the instructions are further executable by the processor to cause the apparatus to:
receive, from the memory device, at least one configuration parameter associated with the channel interface based at least in part on the first request for status information.

19. The apparatus of claim 17, wherein the instructions are further executable by the processor to cause the apparatus to:
receive, from the memory device, an indication of one or more of a type, a data rate, or a timing mode associated with the channel interface based at least in part on the first request for status information.

20. The apparatus of claim 17, wherein the instructions are further executable by the processor to cause the apparatus to:
transmit, from the controller based at least in part on receiving the indication of the initialization status, a second request for state information associated with the channel interface; and
receive one or more state parameters associated with the channel interface based at least in part on transmitting the second request, wherein configuring the channel interface for communicating with the memory device is based at least in part on receiving the one or more state parameters.

21. The apparatus of claim 20, wherein the one or more state parameters include one or more of a current interface mode, use of differential signaling, reference voltage (VrefQ) configuration, ZQ calibration status, warmup cycle configuration, duty cycle correction information, or read/write training information.

22. The apparatus of claim 17, wherein the instructions are further executable by the processor to cause the apparatus to:
transmit a third request to the memory device based at least in part on the indication of the initialization status indicating a power loss for the memory device, wherein the third request indicates for the memory device to perform a reset operation.

23. The apparatus of claim 17, wherein the channel interface supports a plurality of timing modes that each include one or more transmission parameters corresponding to different data communication rates and the first request for status information is transmitted using values of the one or more transmission parameters supported by each of the plurality of timing modes.

24. The apparatus of claim 17, wherein the power signal received at the controller is a power supply for input/output drivers of the memory device.
